(19) United States
(12) Patent Application Publication
(10) Pub. No.: US 2007/0055038 A1
(43) Pub. Date: Mar. 8, 2007

(54) Adducts containing isocyanate groups and composition adhering effectively to painted substrates

(76) Inventors: Peter Gimmnich, Konstanz (DE); Urs Burckhardt, Zurich (CH)

Correspondence Address: BINGHAM, MCCUTCHEN LLP, THREE EMBARCADERO CENTER, 18 FLOOR, SAN FRANCISCO, CA, 94111-4067, US

(21) Appl. No.: 11/512,427

(22) Filed: Aug. 30, 2006

(30) Foreign Application Priority Data
Sep. 1, 2005 (EP) 05108017.4

(51) Int. Cl. C08G 18/16

(52) U.S. Cl. 528/49

(57) ABSTRACT

The present invention relates firstly to adducts of the formula (I) which are obtainable from the reaction of an oligomeric aliphatic polyisocyanate and a compound of the formula HX—R¹. Secondly the invention relates to one-component or two-component compositions which comprise such adducts of the formula (I). The adducts of the formula (I) find a use as adhesion promoters and are suitable in particular for use in elastic adhesives and sealants. The cured one-component or two-component compositions exhibit excellent paint adhesion in tandem with high extensibility.

### TECHNICAL FIELD

The present invention relates to adducts comprising isocyanate groups and also to compositions comprising such adducts.

### PRIOR ART

It has been found that the adhesion of adhesives, sealants and coatings to certain substrates is very difficult to achieve.

Painted surfaces are one such substrate to which adhesion is known to be difficult to achieve. Paints, especially automotive topcoats, are a particularly challenging substrate in this context, since they are optimized primarily for appearance (colour, gloss) and resistance to mechanical and chemical damage, and therefore have surface properties which are generally a hindrance to effective development of adhesion.

Efforts have therefore been made to improve the adhesion through the use of a preliminarily applied undercoat, also referred to as a primer, or through the addition of adhesion promoters. For ease of application, however, the desire on the part of the users is typically for adhesives which exhibit effective substrate adhesion without primers, as disclosed for example in the article “No primers required” by M. Rieder, Kleben and Dichten, Vol. 38, May 1994, pp. 10-17. Adhesives which exhibit effective paint adhesion have been described in a number of instances, an example being WO 99/33930. A further improvement in the adhesion is necessary, however, not least on account of the fact that the automotive industry is continually developing new paints, which pose heightened challenges to the adhesion properties of the adhesive or sealant.

The use of isocyanurates as adhesion promoters is likewise known. U.S. Pat. No. 4,324,879 describes an improved process for trimerizing hexamethylene diisocyanate to the isocyanurate and mentions, for example, the surprisingly effective adhesion to metals of paints comprising this polyisocyanate.

Adducts of polyisocyanates are also known for addition to sealants. U.S. Pat. No. 5,623,044 describes a polyurethane sealant comprising an adduct of a polyisocyanate and a secondary aminosilane or a mercaptosilane, the adduct having on average at least one silane group and at least one isocyanate group, and discloses the aptitude of the sealant for sealing glass with respect to metal.

U.S. Pat. No. 6,649,084 describes a curing agent for laminating adhesives which contains isocyanate groups and comprises, among other components, an adduct of an aliphatic polyisocyanate and a block-polyethylene-polypropylene-monool having a molecular weight of preferably at least 800.

EP-A-0 540 985 describes hydrophilically modified polyisocyanates which are suitable crosslinked for aqueous binders and discloses an adduct of an aliphatic polyisocyanate and a monofunctional polyether alcohol having on average 5 to 9.9 ethylene oxide units, the adduct containing isocyanate groups.

Either the use of these prior art polyisocyanates or adducts produces little or no improvement in the adhesion, or they lead to crosslinking reactions and hence on the one hand to a sharp increase in the viscosity of the uncured composition and, on the other hand, to a sharp reduction in the elasticity of the cured adhesive or sealant.

For polyurethanes to be used as adhesives or sealants, however, it is essential that these adhesives and sealants are elastic.

### DISCLOSURE OF INVENTION

It is an object of the present invention to provide substances which can be added to adhesive, sealant or coating compositions and are capable of enhancing the adhesion of such compositions to paints without a sharp reduction of the ongation at break after curing, and which can therefore be used to produce elastic adhesive bonds, sealing and coatings which even without preliminary use of a primer exhibit effective adhesion to paints, especially automotive topcoats.

Surprisingly it has now been found that adducts according to claim 1 achieve this object. A particular surprise was that, in spite of the absence of silane groups, adducts of this kind are able to lead to such enhancement of the adhesion to paints.

It has been found that these adducts can be employed not only in one-component compositions according to claim 8 but also in two-component compositions according to claim 17, and that the desired properties are achieved. Cured compositions of this kind possess not only effective paint adhesion but also further important mechanical properties, in particular a high tensile strength in tandem with high extensibility.

The compositions are therefore suitable for elastic adhesive bonding, sealing and coating of paint substrates, especially automotive topcoats, and consequently find application in particular in vehicle construction.

### EMBODIMENTS OF THE INVENTION

The invention provides adducts of the formula (I).

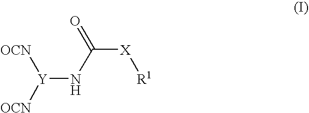

In this formula R¹ is a hydrocarbon radical which has 1 to 20 C atoms. R¹ may optionally contain up to 2 heteroatoms. The substituent R¹, furthermore, contains no silane group.

In addition, X in the formula (I) is a substituent

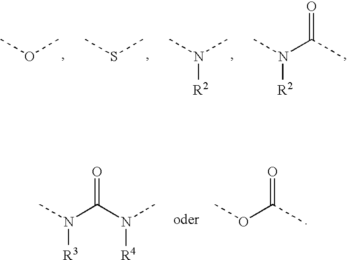

The dashed lines here represent, formally, the bonds to C═O and R¹.

Furthermore, R² is a linear or branched hydrocarbon radical having 1 to 20 C atoms. This hydrocarbon radical optionally contains cyclic fractions. This hydrocarbon radical may further contain, optionally, at least one functional group selected from the group comprising ether, sulphone, nitrile, nitro, carboxylic ester, sulphonic ester and phosphonic ester.

In addition, R³ and R⁴, on the one hand, are independently each a linear or branched hydrocarbon radical having 1 to 20 C atoms and optionally containing cyclic fractions.

On the other hand, R³ and R⁴ together with the urea group form a five- or six-membered ring. This ring can be substituted and contains 3 to 20 C atoms.

Moreover, Y is the radical of an oligomeric aliphatic polyisocyanate having three isocyanate groups, following the removal of all of the isocyanate groups.

The term “organoalkoxysilane” or “silane” for short is used in the present document to refer to compounds in which firstly there are at least one, typically two or three, alkoxy group(s) attached directly to the silicon atom (via a Si—O bond) and which, secondly, have at least one organic radical attached directly to the silicon atom (via a Si—C bond). Correspondingly, the term “silane group” refers to the silicon-containing group attached to the organic radical of the organoalkoxysilane. The organoalkoxysilanes, or their silane groups, have the property of hydrolysing on contact with moisture. This hydrolysis is accompanied by the formation of organosilanols, i.e. organosilicon compounds containing one or more silanol groups (Si—OH groups) and, as a result of subsequent condensation reactions, organosiloxanes, i.e. organosilicon compounds containing one or more siloxane groups (Si—O—Si groups).

“Silane group” refers in the present document to a hydrolysable, silicon-containing group attached to the organic radical of an organoalkoxysilane. Terms such as “aminosilane”, “hydroxysilane” and “mercaptosilane” are used to refer to silanes which contain the corresponding functional group, i.e. an aminoalkylalkoxysilane, hydroxyalkylalkoxysilane and mercaptoalkylalkoxysilane, here.

An “oligomer” is a compound built up through the linkage of a few monomers, with even dimers and trimers being classed as oligomers. An “aliphatic oligomeric polyisocyanate” is an individual oligomer or a mixture of oligomers of aliphatic diisocyanates, it being possible for these oligomers to be built up from like or different diisocyanates and also for small molecules such as water or carbon dioxide to be incorporated or eliminated in the course of the oligomerization.

The term “polymer” embraces in the present document, on the one hand, a group of chemically uniform macromolecules which nevertheless differ in respect of degree of polymerization, molar mass and chain length and which has been prepared by a polymerization reaction (addition polymerization, polyaddition, polycondensation). On the other hand the term also embraces derivatives of such a group of macromolecules from polymerization reactions, in other words compounds which have been obtained by reactions, such as addition reactions or substitution reactions, for example, of functional groups on existing macromolecules and which may be chemically uniform or chemically non-uniform. The term further embraces what are known as prepolymers—that is, reactive oligomeric preadducts whose functional groups are involved in the construction of macromolecules.

The prefix “poly” in substance names such as “polyisocyanate” or “polyol”, for example, refers in the present document to the fact that the substance in question formally contains two or more of the functional group which occurs in its name—in the example, isocyanate groups or hydroxyl groups—per molecule.

The adduct of the formula (I) is preparable for example through the reaction of at least one aliphatic oligomeric polyisocyanate of the formula (II) with at least one compound of the formula (III),

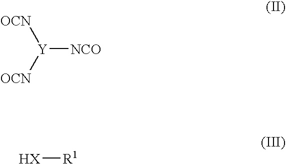

The substituents R¹, Y and X have the definition already described.

Suitable aliphatic oligomeric polyisocyanates of the formula (II) are trimers of aliphatic diisocyanates, such as, for example, the trimers of the following commercially customary diisocyanates:

hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI), 1,4-diisocyanato-2,2,6-trimethylcyclohexane (TMCDI), xylylene m- and p-diisocyanate (XDI), tetramethylxylylene 1,3- and 1,4-diisocyanate (TMXDI), and 1,3 and 1,4-bis(isocyanatomethyl)cyclohexane, preferably HDI and IPDI.

Technical forms of these trimers are typically mixtures of substances having different degrees of polymerization and chemical structures. Suitable forms are technical oligomer mixtures which have an average NCO functionality of preferably 2,4 to 4.0 and contain, in particular, isocyanurate, iminooxadiazinedione or biuret groups. In addition there may also be allophanate, carbodiimide, uretonimine or oxadiazinetrione groups present. These oligomeric mixtures preferably comprise a majority of trimers of the formula (II), in particular in a mixture with dimers and the lower higher oligomers. Suitable commercially available technical oligomer mixtures of aliphatic diisocyanates are HDI biuretes, for example as Desmodur® N 100 and N 3200 (Bayer), Tolonate® HDB and HDB-LV (Rhodia) and Duranate® 24A-100 (Asahi Kasei); HDI isocyanurates, for example as Desmodur® N 3300, N 3600 and N 3790 BA (all from Bayer), Tolonate® HDT, HDT-LV and HDT-LV2 (Rhodia), Duranate® TPA-100 and THA-100 (Asahi Kasei) and Coronate® HX (Nippon Polyurethanes); HDI uretdiones, for example as Desmodur® N 3400 (Bayer); HDI iminooxadiazinediones, for example as Desmodur® XP 2410 (Bayer); HDI allophanates, for example as Desmodur® VP LS 2102 (Bayer); and IPDI isocyanurates, for example in solution as Desmodur® Z 4470 (Bayer) or in solid form as Vestanat® T1890/100 (Degussa).

Preference is given to the trimers of HDI and/or IPDI, especially the isocyanurates.

Suitable compounds of the formula (III) are
monoalcohols, examples being methanol, ethanol, propanol, isopropanol, n-butanol, isobutanol, pentanol, hexanol, isohexanol, heptanol, octanol, 2-ethyl-1-hexanol, cyclohexanol, and further linear or branched or cyclic monoalcohols having up to 20 C atoms and possibly containing up to 3 heteroatoms, examples being tetrahydrofurfuryl alcohol or D,L-α,β-isopropylidene glycol (Solketal®);
monophenols, examples being phenol, cresols and other alkylmonophenols such as nonylphenols, 1- and 2-naphthol and nitrophenols;
aliphatic monothiols, examples being butanethiol, hexanethiol, octanethiol, cyclohexanethiol or benzyl mercaptan; thioglycolic esters such as methyl thioglycolate or 2-ethylhexyl thioglycolate;
aromatic monomercapto compounds, examples being 2-mercaptobenzothiazole or 2-mercaptobenzoxazole;
secondary aliphatic monoamines, examples being dimethylamine, N-ethylmethylamine, diethylamine, N-ethylisopropylamine, dipropylamine, diisopropylamine, N-methylbutylamine, N-methyltert-butylamine, N-ethylbutylamine, dibutylamine, disobutylamine, N-methylhexylamine, N-methylallylamine, N-methylbenzylamine, N-tert-butylbenzylamine, N-methylcyclohexylamine, N-allylcyclohexylamine, dicyclohexylamine, aziridine, azetidine, pyrrolidine, piperdine, homopiperidine, morpholine, thiomorpholine, 1,2,3,4-tetra-hydroisoquinoline, decahydroquinoline, perhydroisoquinoline, and also further secondary aliphatic monoamines having hydrocarbon chains with up to 20 C atoms; secondary monoamines based on a polyoxypropylene backbone; and also the products from the Michael-like addition of primary monoamines such as, for example, methylamine, ethylamine, propylamine, butylamine, pentylamine, hexylamine, heptylamine, octylamine, nonylamine, decylamine, allylamine, cyclohexylamine, benzylamine and also further primary monoamines having up to 20 C atoms with Michael acceptors such as maleic diesters, fumaric diesters, citraconic diesters, acrylic esters, methacrylic esters, cinnamic esters, itaconic diesters, vinylphosphonic diesters, vinylsulphonic aryl esters, vinyl sulphones, vinyl nitriles, 1-nitroethylenes or Knoevenagel condensation products such as those, for example, of malonic diesters and aldehydes such as formaldehyde, acetaldehyde or benzaldehyde, such as, for example, diethyl N-butylaminosuccinate;
secondary aromatic monoamines, examples being N-methylaniline, N-methyltoluidine and diphenylamine;
secondary monocarboxamides, examples N-methyl-formamide, N-methylacetamide, and also lactams such as pyrrolidone, valerolactam and caprolactam;
trisubstituted monoureas, examples being trimethylurea, tributylurea, N-methyl-N,N′-ethyleneurea and N-methyl-N,N′-propyleneurea;
monocarboxylic acids, examples being formic acid, acetic acid, propionic acid, butyric acid, valeric acid, caproic acid, 2-ethylcaproic acid, lauric acid or benzoic acid.

Preferred compounds of the formula (III) are aliphatic monoalcohols, especially 2-ethyl-1-hexanol, aliphatic monothiols, especially thioglycolic esters such as 2-ethylhexyl thioglycolate, and secondary aliphatic monoamines, especially dibutylamine, and the diethyl ester of N-methylamino-, N-ethylamino-, N-propylamino-, N-butylamino- and N-(2-ethylhexyl)amino-succinic acid.

It is clear to the skilled person that the compounds of the formula (III) are monofunctional with respect to aliphatic polyisocyanates, in other words that a compound of the formula (III) reacts only with one isocyanate group, or, in other words, that the substituent R¹ contains no NCO-reactive groups.

Unsuitable as compounds of the formula (III) are, firstly, polyethylene glycol monoalcohols (polyethylene glycol monoethers), or monoalcohols based on copolymers of ethylene oxide and propylene oxide, since on account of the known hydrophilicity of the oxyethylene units with monoalcohols of this kind, notable amounts of water are introduced. This water reacts with the isocyanate groups and leads to further reactions which result in viscosity increases, which is undesirable for use in elastic adhesives, sealants or coatings. Removing the water from hydrophilic monoalcohols of this kind would be very inconvenient and costly.

Also unsuitable as compounds of the formula (III) are monoalcohols having a total of more than 3 heteroatoms, examples being monoalcohols having more than 2 ether groups. Adducts based on such monoalcohols with aliphatic oligomeric polyisocyanates result in a significantly poorer adhesion than those with adducts according to formula (I).

In the case of adducts of the formula (I) which have been prepared by the reaction between an aliphatic oligomeric polyisocyanate of the formula (II) with a carboxylic acid it is clear to the skilled person that the adducts may eliminate carbon dioxide at elevated temperature, for example at 60 to 120°C., with the formation of amide groups.

The reaction is typically accomplished by reacting the aliphatic oligomeric polyisocyanate of the formula (II) and the compound of the formula (III) by standard processes, for example at temperatures of 0°C. to 100°C., with the additional use where appropriate of suitable catalysts, the isocyanate groups of the polyisocyanate of the formula (II) being introduced in relation to the isocyanate-reactive group HX of the compound of the formula (III) in such a way as to form on average adducts of the formula (I) having two free isocyanate groups. Where appropriate the adduct of the formula (I) can be prepared with the additional use of solvents and/or plasticizers, in which case the solvents and plasticizers used ought not to contain any isocyanate-reactive groups. Particularly in the event that one of the starting substances of the formulae (II) or (III) or the adduct of the formula (I) has a solid form at room temperature or at reaction temperature, it is advantageous to conduct the reaction in the presence of a solvent and/or plasticizer, the use of the plasticizer being preferred.

For the preparation of the adduct of the formula (I) it is of great advantage if virtually anhydrous or at least vigorously dried reactants are used and if not only the entire preparation but also the storage of the adduct of the formula (I) take place accompanied by substantial exclusion of moisture.

As already mentioned, the oligomeric aliphatic polyisocyanate of the formula (II) is typically employed as part of a technical mixture having an average NCO functionality of 2.4 to 4.0. In the reaction of a technical mixture of this kind with a compound of the formula (III) to form a reaction product which includes as a constituent at least one adduct of the formula (I), the stoichiometric ratio between the NCO groups and the HX groups is preferably selected such that the reaction product has an average NCO functionality of 1.8 to 2.6, in particular approximately 2.

The adduct of the formula (I) can be used as a constituent of compositions, in particular of polymer-comprising compositions, such as primers, paints, varnishes, adhesives, sealants, coatings and floorcoverings, in particular as adhesion promoters for various substrates, examples being inorganic substrates such as glass, glass ceramic, concrete, mortar, brick, tile, plaster and natural stones such as granite or marble; metals or alloys such as aluminium, steel, non-ferrous metals, galvanized metals; organic substrates such as wood, plastics such as PVC, polycarbonates, PMMA, polyesters, epoxy resins; coated substrates such as powder-coated metals or alloys; and also inks and paints.

The present invention further provides a one-component composition which comprises at least one adduct of the formula (I), or, respectively, the preferred embodiments thereof, such as has or have been described above already in detail, and also at least one polymer P.

The polymer P contains isocyanate groups and optionally silane groups.

In one embodiment the polymer P is a polyurethane polymer P1 containing isocyanate groups.

In another embodiment polymer P is a polyurethane polymer P2 containing not only isocyanate groups but also silane groups.

The term “polyurethane polymer” embraces for the purposes of the present document all polymers prepared by the diisocyanate polyaddition process. This includes even those polymers which are virtually or entirely free from urethane groups, such as polyether-polyurethanes, polyester-polyurethanes, polyether-polyureas, polyureas, polyester-polyureas, polyisocyanurates, polycarbodiimides, etc.

A polyurethane polymer P1 containing isocyanate groups is obtainable through the reaction of at least one polyisocyanate with at least one polyol.

This reaction can be accomplished by reacting the polyol and the polyisocyanate by standard processes, at temperatures for example of 50° C. to 100° C., with the additional use where appropriate of suitable catalysts, the polyisocyanate being introduced in an amount such that its isocyanate groups are present in a stoichiometric excess in relation to the hydroxyl groups of the polyol.

Examples of polyols which can be used for preparing a polyurethane polymer containing isocyanate groups include the following commercially customary polyols, or any desired mixtures thereof:
polyoxyalkylene polyols, also called polyether polyols or oligoetherols, which are polymerization products of ethylene oxide, 1,2-propylene oxide, 1,2- or 2,3-butylene oxide, tetrahydrofuran or mixtures thereof, optionally polymerized by means of a starter molecule having two or more active hydrogen atoms such as, for example, water, ammonia or compounds having two or more OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the aforementioned compounds. It is possible to use not only polyoxyalkylene polyols which have a low level of unsaturation (measured in accordance with ASTM D-2849-69 and reported in milliequivalents of unsaturation per gram of polyol (meq/g)), prepared for example with the aid of what are called double metal cyanide complex catalysts (DMC catalysts), but also polyoxyalkylenepolyols having a higher level of unsaturation, prepared for example using anionic catalysts such as NaOH, KOH, CsOH or alkali metal alkoxides.

Particularly suitable are polyoxyalkylenediols or polyoxyalkylenetriols, especially polyoxypropylenediols or polyoxypropylenetriols.

Especially suitable are polyoxyalkylenediols or polyoxyalkylenetriols having a level of unsaturation of less than 0.02 meq/g and having a molecular weight in the range of 1000-30000 g/mol, and also polyoxypropylenediols and -triols having a molecular weight of 400-8000 g/mol. The term “molecular weight” refers in the present document to the molecular weight average Mₙ.

Likewise particularly suitable are what are called ethylene oxide-terminated (“EO-endcapped”, ethylene oxide-endcapped) polyoxypropylenepolyols. The latter are special polyoxypropylenepolyoxyethylenepolyols which are obtained, for example, by subjecting straight polyoxypropylenepolyols, especially polyoxypropylene-diols and -triols, after the end of the polypropoxylation reaction, to further alkoxylation with ethylene oxide and which as a result contain primary hydroxyl groups.
Polyetherpolyols grafted with styrene-acrylonitrile or acrylonitrile-methyl methacrylate.
Polyesterpolyols, also called olgioesterols, prepared for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, l,l,l-trimethylolpropane or mixtures of the aforementioned alcohols with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid or mixtures of the aforementioned acids, and also polyesterpolyols from lactones such as ε-caprolactone for example.
Polycarbonatepolyols of the kind obtainable by reacting, for example, the abovementioned alcohols—those used to synthesize the polyesterpolyols—with dialkyl carbonates, diaryl carbonates or phosgene.
Polyacrylate- and polymethacrylatepolyols.
Polyhydroxy-functional polyhydrocarbons, also called oligohydrocarbonols, such as, for example polyhydroxy-functional ethylene-propylene, ethylene-butylene or ethylene-propylene-diene copolymers, of the kind prepared by Kraton Polymers, for example, or polyhydroxy-functional copolymers comprising dienes such as 1,3-butanediene or diene mixtures and vinyl monomers such as styrene, acrylonitrile or isobutylene, or polyhydroxy-functional polybutadienepolyols, such as, for example, those prepared by copolymerizing 1,3-butadiene and allyl alcohol.
Polyhydroxy-functional acrylonitrile/polybutadiene copolymers, of the kind preparable for example from epoxides or amino alcohols and carboxyl-terminated acrylonitrile/polybutadiene copolymers (available commercially under the name Hycar® CTBN from Hanse Chemie).

These stated polyols have an average molecular weight of 250-30000 g/mol, in particular of 1000-30000 g/mol, and an average OH functionality in the range from 1.6 to 3.

In addition to these stated polyols it is possible additionally to use small amounts of low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned dihydric and higher polyhydric alcohols, and also mixtures of the aforementioned alcohols, in the context of preparing the polyurethane polymer.

Examples of polyisocyanates which can be used for preparing a polyurethane polymer containing isocyanate groups include the following commercially customary polyisocyanates:

aromatic polyisocyanates such as toluylene 2,4- and 2,6-diisocyanate and any desired mixtures of these isomers (TDI), diphenylmethane 4,4′-, 2,4′- and 2,2′-diisocyanate and any desired mixtures of these isomers (MDI), mixtures of MDI and MDI homologues (“polymeric MDI” (PMDI)), phenylene 1,3- and 1,4-diisocyanaate, 2,3,5,6-tetramethyl-1,4-diisocyanatobenzene, naphthalene 1,5-diisocyanate (NDI), 3,3′-dimethyl-4,4′-diisocyanatobiphenyl (TODI), tris(4-isocyanatophenyl)methane, tris(4-isocyanatophenyl) thiophosphate; cycloaliphatic polyisocyanates such as cyclohexane 1,3- and 1,4-diisocyanate and any desired mixtures of these isomers, 1-isocyanato-3,3,5-trimethyl-5-isocyanatomethylcyclohexane (isophorone diisocyanate or IPDI), perhydrodiphenylmethane 2,4′- and 4,4′-diisocyanate (HMDI), 1,4-diisocyanato-2,2,6-trimethylcyclohexane (TMCDI); aliphatic and araliphatic polyisocyanates such as tetramethylene 1,4-diisocyanate, 2-methylpentamethylene 1,5-diisocyanate, hexamethylene 1,6-diisocyanate (HDI), 2,2,4- and 2,4,4-trimethylhexamethylene 1,6-diisocyanate (TMDI), dodecamethylene 1,12-diisocyanate, lysine diisocyanate and lysine ester diisocyanate, 1,3- and 1,4-bis(isocyanatomethyl)cyclohexane (BIC), xylylene m- and p-diisocyanate (m- and p-XDI), 1,3,5-tris(isocyanatomethyl)benzene, m- and p-tetramethylxylylene 1,3- and 1,4-diisocyanate (m- and p-TMXDI), bis(1-isocyanato-1-methylethyl)naphthalene, α,α,α′,α′,α″α″-hexamethyl-mesitylene 1,3,5-triisocyanate, dimer and trimer fatty acid isocyanates such as 3,6-bis(9-isocyanatononyl)-4,5-di(1-heptenyl)cyclohexene (dimeryl diisocyanate); oligomers and polymers of the aforementioned polyisocyanates, and also any desired mixtures of the aforementioned polyisocyanates and their oligomers. Preference is given to MDI, TDI, HDI and IPDI.

A polyurethane polymer P2 containing not only isocyanate groups but also silane groups is obtainable for example through the reaction of at least one polyurethane polymer P1 containing isocyanate groups, as described beforehand, with an organoalkoxysilane which contains at least one isocyanate-reactive group. In this case it is necessary to ensure that the organoalkoxysilane is used substoichiometrically in relation to the isocyanate groups of the polyurethane polymer.

The reaction of at least one polyurethane polymer P1 containing isocyanate groups with a silane which contains a NCO-reactive group can be accomplished by reacting the silane with the isocyanate groups of the polyurethane polymer, where appropriate in the presence of a suitable catalyst, the silane being introduced in an amount such that its isocyanate-reactive group is present in a substoichiometric amount relative to the isocyanate groups of the polyurethane polymer. This reaction may take place immediately after the preparation of the polyurethane polymer containing isocyanate groups, or alternatively may take place at a later point in time—for example, when mixing the polyurethane polymer containing isocyanate groups with further ingredients, such as when preparing an adhesive, for example. A polyurethane polymer P2 containing both isocyanate groups and silane groups typically has a ratio between isocyanate groups and silane groups which is in the range from 10/1 to 1/1, preferably 6/1 to 2/1.

Silanes having an NCO-reactive group that are suitable for reaction with a polyurethane polymer P1 containing isocyanate groups are
mercaptosilanes, such as 3-mercaptopropyltrimethoxysilane, 3-mercaptopropyldimethoxymethylsilane and also their analogues with ethoxy or isopropoxy groups instead of the methoxy groups on the silicon;
hydroxysilane, such as 3-hydroxypropyltrimethoxysilane, 3-hydroxypropyldimethoxymethylsilane and also their analogues with ethoxy or isopropoxy groups instead of the methoxy groups on the silicon;
aminosilanes have a secondary amino group—also referred to below as “secondary aminosiloxanes” —which derive from commercially customary aminosilanes having a primary amino group. Examples of commercially customary aminosilanes having a primary amino group are 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxysilane, 4-amino-3-methylbutyltrimethoxysilane, 4-amino-3,3-dimethylbutyltrimethoxymethylsilane, 4-amino-3,3-dimethylbutyldimethoxymethylsilane, 2-aminoethyl-trimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, and also their analogues with ethoxy or isopropoxy groups instead of the methoxy groups on the silicon. Suitable aminosilanes having a secondary amino group are, correspondingly, the derivatives of the exemplified aminosilanes having a primary amino group that carry a hydrocarbon radical on the nitrogen atom, such as a methyl, ethyl, butyl, cyclohexyl or phenyl group; multiply silane-functional secondary aminosilanes such as, for example, bis(trimethoxysilylpropyl)amine; and also the products of the Michael-like addition of the exemplified aminosilanes have a primary amino group with Michael acceptors such as maleic diesters, fumaric diesters, citraconic diesters, acrylic esters, methacrylic esters, cinnamic esters, itaconic diesters, vinylphosphonic diesters, vinylsulphonic aryl esters, vinyl sulphones, vinyl nitriles, 1-nitroethylenes or Knoevenagel condensation products such as those, for example, of malonic diesters and aldehydes such as formaldehyde, acetaldehyde or benzaldehyde.

Particularly suitable aminosilanes having a secondary amino group are N-methyl-3-aminopropyltrimethoxysilane, N-methyl-3-aminopropyldimethoxymethylsilane, N-ethyl-3-amino-2-methylpropyltrimethoxysilane, N-ethyl-3-amino-2-methylpropyldimethoxymethylsilane, N-butyl-3-amino-propyltrimethoxysilane, N-butyl-3-aminopropyldimethoxymethylsilane, N-butyl-4-amino-3,3-dimethylbutyltrimethoxysilane, N-butyl-4-amino-3,3-dimethylbutyldimethoxymethylsilane, N-cyclohexyl-3-aminopropyltrimethoxysilane, N-cyclohexyl-3-aminopropyldimethoxymethylsilane, N-phenyl-3-aminopropyltrimethoxysilane, N-cyclohexylaminomethyltrimethoxysilane, N-phenylaminomethyltrimethoxysilane, N-phenylaminomethyldimethoxymethylsilane, the products of the Michael-like addition of 3-aminopropyltrimethoxysilane, 3-aminopropyldimethoxymethylsilane, 4-amino-3,3-dimethylbutyltrimethoxysilane, 4-amino-3,3-dimethylbutyldimethoxymethylsilane, aminomethyltrimethoxysilane or aminomethyldimethoxymethylsilane with dimethyl, diethyl or dibutyl maleate, tetrahydrofurfuryl, isobornyl, hexyl, lauryl, stearyl, 2-hydroxyethyl or 3-hydroxypropyl acrylate, dimethyl, diethyl or dibutyl phosphonate, acrylonitrile, 2-pentenenitrile, fumaronitrile or β-nitrostyrene, and also the analogues of the aforementioned aminosilanes with ethoxy groups instead of the methoxy groups on the silicon.

The adduct of the formula (I) is present typically in an amount of 0.1% to 10% by weight, preferably 0.3% to 6% by weight and in particular 0.5% to 5% by weight, based on the one-component composition.

It is essential here that the preparation of the adduct of the formula (I) take place separately from the preparation of the polymer P. The aliphatic oligomeric polyisocyanate of the formula (II) used to prepare the adduct of the formula (I) ought to come into contact neither with a polyisocyanate used to prepare a polymer P nor with the polymer P itself before the reaction with the compound of the formula (III) is concluded. This ensures that the isocyanate-reactive group HX of the compound of the formula (III) reacts exclusively with the isocyanate groups of the aliphatic oligomeric polyisocyanate of the formula (II). It is therefore possible, for preparing the one-component composition, first to prepare the adduct of the formula (I) and to mix the separately prepared polymer P into said adduct, or else to mix the separately prepared adduct of the formula (I) into the polymer P.

It is advantageous if, in addition to the adduct of the formula (I) and to the polymer P, the one-component composition comprises at least one catalyst KAT-1. Suitable KAT-1 catalysts are compounds which are stable on storage together with isocyanate groups and, where appropriate, silane groups and which accelerate the isocyanate group and/or, where appropriate, silane group reactions that lead to the curing of the composition. Catalysts identified as suitable catalysts KAT-1 are metal compounds, for example tin compounds, examples being dialkyltin dicarboxylates such as dibutyltin diacetate, dibutyltin bis(2-ethylhexanoate), dibutyltin dilaurate, dibutyltin dipalmitate, dibutyltin distearate, dibutyltin dioleate, dibutyltin dilinolate, dibutyltin dilinolenate, dibutyltin diacetylacetonate, dibutyltin maleate, dibutyltin bis(octylmaleinate), dibutyltin phthalate, dimethyltin dilaurate, dioctyltin diacetate or dioctyltin dilaurate, dialkyltin mercaptides such as dibutyltin bis(2-ethylhexyl mercaptoacetate) or dioctyltin bis(2-ethylhexyl mercaptoacetate), dibutyltin dichloride, monobutyltin trichloride, alkyltin thioesters, dibutyltin oxide, dioctyltin oxide, tin (II) carboxylates such as tin(II) octoate, tin(II) 2-ethylhexanoate, tin(II) laurate, tin (II) oleate or tin(II) naphthenate, stannoxanes such as lauryl-stannoxane, bismuth compounds such as bismuth(III) octoate, bismuth(III) neodecanoate or bismuth(III) oxinates; weakly basic tertiary amine compounds such as, for example, 2,2′-dimorpholinodiethyl ether and other morpholine ether derivatives; and also combinations of the compounds specified, especially of metallic compounds and compounds containing amino groups.

Further to the adduct of the formula (I), to the polymer P and to the optional catalyst KAT-1 the one-component composition may comprise further constituents, which should not, however, impair the stability of the composition on storage—that is, they ought not significantly to initiate, in the course of storage, reactions on the part of the isocyanate groups and, where appropriate, of the silane groups of a kind which lead to crosslinking of the composition. In particular this means that such further constituents ought not to contain, or release, any more than traces of water. Additional constituents that may be present include the following well-known auxiliaries and adjuvants:
plasticizers, examples being esters of organic carboxylic acids or their anhydrides, phthalates, such as dioctyl phthalate or diisodecyl phthalate, adipates, such as dioctyl adipate, sebacates, polyols such as polyoxyalkylenepolyols or polyesterpolyols, for example, organic phosphoric and sulphonic esters or polybutenes;
solvents, examples being ketones such as acetone, methyl ethyl ketone, diisobutyl ketone, acetonyl acetone, mesityl oxide, and also cyclic ketones such as methylcyclohexanone and cyclohexanone; esters such as ethyl acetate, propyl acetate or butyl acetate, formates, propionates or malonates; ethers such as ketone ethers, ester ethers and dialkyl ethers such as diisopropyl ether, diethyl ether, dibutyl ether, diethylene glycol diethyl ether and also ethylene glycol diethyl ether; aliphatic and aromatic hydrocarbons such as toluene, xylene, heptane, octane and also various petroleum fractions such as naphtha, white spirit, petroleum ether or benzine; halogenated hydrocarbons such as methylene chloride; and also N-alkylated lactams such as N-methylpyrrolidone, N-cyclohexylpyrrolidone or N-dodecylpyrrolidone, for example;
organic and inorganic fillers, such as, for example, ground or precipitated calcium carbonates, optionally with a stearate coating, especially finely divided coated calcium carbonate, carbon blacks, kaolins, aluminas, silicas, PVC powders or hollow beads; fibres, of polyethylene for example; pigments;
further catalysts common in polyurethane chemistry;
reactive diluents and crosslinkers, examples being polyisocyanates such as MDI, PMDI, TDI, HDI, dodecamethylene 1,12-diisocyanate, cyclohexane 1,3- or 1,4-diisocyanate, IPDI, perhydrodiphenylmethane 2,4′- and 4,4′-diisocyanate, tetramethylxylylene 1,3- and 1,4-diisocyanate, oligomers and polymers of these polyisocyanates, especially isocyanurates, carbodiimides, uretonimines, biurets, allophanates and iminooxadiazinediones of the aforementioned polyisocyanates, adducts of polyisocyanates with short-chain polyols, and also adipic dihydrazide and other dihydrazides;
latent polyamines such as, for example, polyaldimines, polyketimines, polyenamines, polyoxazolidines, polyamines microencapsulated or adsorbed on a zeolite, and also amine-metal complexes, preferably polyaldimines formed from aliphatic primary polyamines and aliphatic, α-trisubstituted aldehydes such as, for example, 2,2-dimethyl-3-acyloxypropanal, especially 2,2-dimethyl-3-lauroyloxypropanal, and also complexes formed between methylenedianiline (MDA) and sodium chloride (available as a dispersion in diethylhexyl phthalate or diisodecyl phthalate under the trade name Caytur® 21 from Crompton Chemical);
dryers, such as, for example, p-tosyl isocyanate and other reactive isocyanates, orthoformic esters, calcium oxide; vinyltrimethoxysilane or other rapidly hydrolysing silanes such as, for example, organoalkoxysilanes which have a functional group positioned α to the silane group, or molecular sieves;
rheology modifiers such as, for example, thickeners, examples being urea compounds, polyamide waxes, bentonites or pyrogenic silicas;
adhesion promoters, especially silanes such as, for example, epoxysilanes, vinylsilanes, (meth)acryloylsilanes, isocyanatosilanes, carbamatosilanes, S-(alkylcarbonyl)mercaptosilanes and aldiminosilanes, and also oligomeric forms of these silanes;
heat, light and UV stabilizers; flame retardants;
surface-active substances such as, for example, wetting agents, flow control agents, deairating agents or defoamers;
biocides such as, for example, algaecides, fungicides or substances which inhibit fungal growth; and also further substances typically employed in one-component polyurethane compositions.

A one-component composition comprising at least one adduct of the formula (I), at least one polymer P and also, where appropriate, further constituents is prepared and kept in the absence of moisture. It is stable on storage, which means that it can be kept in the absence of moisture in suitable packaging or a suitable contrivance, such as a drum, a bag, or a cartridge, for a period ranging from several months up to a year or more, without undergoing alteration to any service-relevant extent in its application properties or in its properties after curing.

When a polymer composition of this kind is applied to at least one solid body or article, the silane groups and/or isocyanate groups of the polymer P come into contact with moisture. The reaction of isocyanate groups with moisture is accompanied by elimination of carbon dioxide to form amino groups, which rapidly react with further isocyanate groups to form urea groups. The silane groups have the capacity to undergo hydrolysis on contact with moisture. In doing so they form organosilanols (organic silicon compounds containing one or more silanol groups, Si—OH groups) and, by means of subsequent condensation reactions, form organosiloxanes (organosilicon compounds containing one or more siloxane groups, Si—O—Si groups). As a result of such reactions the composition ultimately cures to an elastic material; this process is also referred to as crosslinking. Alternatively the water needed for the curing reaction can come from the air (atmospheric humidity), or the composition can be contacted with a water-containing component, by being spread-coated, for example, with a smoothing agent, or by being sprayed, or else the composition can have a water-containing component added to it, in the form for example of a aqueous paste, which is mixed in via a static mixer, for example. The composition cures rapidly and completely, irrespective of whether the water required for this process comes from the air or is added. The mode of curing via atmospheric humidity, which is particularly important in practical application, takes place completely within a few days under suitable or climatic conditions, for example at 23° C. and 50% relative atmospheric humidity.

Where appropriate, the curing of the polymer composition may also be accelerated by supply of heat, especially when the composition comprises thermally latent polyamines, such as amine-metal complexes or microencapsulated polyamines, which react with the polymer P only when an activation temperature has been exceeded, 80 to 160° C. for example. A further aspect of the present invention is a two-component composition consisting of two components K1 and K2.

Component K1 comprises at least one adduct of the formula (I), or a preferred embodiment thereof as has or have already been described above in detail, and also at least one polyisocyanate.

Component K2 comprises at least one polyol and/or at least one polyamine.

Suitable polyisocyanates of component K1 include not only the polyisocyanates specified for preparing a polymer P but also the isocyanato-functional polyurethane polymers P1 already described. Preference is given to PMI (“polymeric MDI”), known for example under trade names such as Desmodur® VL, Desmodur® VL 50, Desmodur® VL R 10, Desmodur® VL R 20, Desmodur® VKS 20 F (all from Bayer), Isonate® M 309, Voranate® M 229, Voranate® M 580 (all from Dow) or Lupranat M 10 R (from BASF), room-temperature-liquid forms of MDI (known as “modified MDI”), which represent mixtures of MDI with MDI derivatives, such as MDI carbodiimides or MDI uretonimines, for example, and are known for example under trade names such as Desmodur® CD, Desmodur® PF, Desmodur® PC (all from Bayer), and also polyurethane polymers P1 prepared by using MDI, HDI, TDI or HDI.

Suitable polyols of component K2 are the same polyols already indicated as being suitable for the preparation of the polymer P. Particularly suitable polyols are high-functionality polyols, examples being triols, tetrols and higher functionality polyols; polyetherpolyols which contain amine or are prepared starting from amines (ethylenediamine, for example); short-chain polyetherpolyols having molecular weights of 300 to 2000; hydrophobic polyols, especially fatty polyols such as, for example, castor oil or the polyols known under the trade name Sovermol® from Cognis; and also diol chain extenders such as 1,4-butanediol, 1,6-hexanediol, ethylene glycol, diethylene glycol, propylene glycol, dipropylene glycol, 1,4-bis(hydroxyethyl)hydroquinone, 1,4-cyclohexanediol or N,N′-bis(hydroxyethyl)piperazine.

Suitable polyamines of component K2 are primary aliphatic polyamines such as, for example, ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 2-butyl-2-ethyl-1,5-pentanediamine, 1,6-hexanediamine (HMDA), 2,2,4- and 2,4,4-trimethyl-hexamethylenediamine and mixtures thereof (TMD), 1,7-heptanediamine, 1,8-octanediamine, 2,4-dimethyl-1,8-octanediamine, 4-aminomethyl-1,8-octanediamine, 1,9-nonanediamine, 2-methy-1,9-nonanediamine, 5-methyl-1,9-nonanediamine, 1,10-decanediamine, isodecanediamine, 1,11-undecanediamine, 1,12-dodecanediamine, methyl-bis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines such as 1,3- and 1,4-diaminocyclohexane, bis(4-aminocyclohexyl)methane (H₁₂MDA), bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane (M-MECA), 1-amino-3-aminomethyl-3,5,5-trimethylcyclohexane (isophorone-diamine or IPDA); 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, produced by Mitsui Chemicals), 3(4),8(9)-bis(aminomethyl)tricyclo[5.2.1.0^{2,6}]decane, 3,9-bis(3-aminopropyl)-2,4,8,10-tetraoxaspiro[5.5]undecane, 1,3-xylylenediamine (MXDA), 1,4-xylyenediamine (PXDA), aliphatic polyamines containing ether groups, such as bis(2-aminoethyl)ether, 4,7-dioxadecane-1,10-diamine, 4,9-dioxadodecane-1,12-diamine and higher oligomers thereof, polyoxyalkylene-polyamines having theoretically two or three amino groups, obtainable for example under the name Jeffamine® (produced by Huntsman Chemicals), and also polyaminoamides; secondary aliphatic polyamines such as, for example, N,N′-dibutylethylenediamine; N,N′-di-tert-butyl-ethylene-diamine, N,N′-diethyl-1,6-hexanediamine, 1-(l-methyl-ethylamino)-3-(1-methylethylaminomethyl)-3,5,5-trimethylcyclohexane (Jefflink® 754 from Huntsman), N4-cyclohexyl-2-methyl-N2-(2-methylpropyl)-2,4-pentanediamine, N,N′-dialkyl-1,3-xylylenediamine, bis(4-(N-alkylamino)cyclohexyl)methane, N-alkylated polyether-amines, products of the Michael-like addition of the primary aliphatic polyamines exemplified with Michael acceptors such as maleic diesters, furmaric diesters, citraconic diesters, acrylic esters, methacrylic esters, cinnamic esters, itaconic diesters, vinylphosphonic diesters, vinylsulphonic aryl esters, vinyl sulphones, vinyl nitriles, 1-nitroethylenes or Knoevenagel condensation products such as those, for example, of malonic diesters and aldehydes such as formaldehyde, acetaldehyde or benzaldehyde; aliphatic polyamines having primary and secondary amino groups, such as N-butyl-1,6-hexanediamine, for example; and also primary and/or secondary aromatic polyamines such as, for example, m- and p-phenylenediamine, 4,4′-diaminodiphenylmethane (MDA), 3,3′-dichloro-4,4′-diaminodiphenylmethane (MOCA), mixtures of 3,5-dimethylthio-2,4- and -2,6-tolylenediamine (available as Ethacure® 300 from Albemarle), mixtures of 3,5-diethyl-2,4- and -2,6-tolylenediamine (DETDA), 3,3′,5,5′-tetraethyl-4,4′-diaminodiphenylmethane (M-DEA), 3,3′,5′5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′,5,5′-tetra-isopropyl-4,4′-diaminodiphenylmethane (M-DIPA), 4,4′-diaminodiphenyl sulphone (DDS), 4-amino-N-(4-aminophenyl)benzenesulphonamide, 5,5′-methylenedianthranilic acid, dimethyl 5,5′-methylenedianthranilate, 1,3-propylenebis (4-aminobenzoate), 1,4-butylenebis(4-aminobenzoate), polytetramethylene oxide bis(4-aminobenzoate) (available as Versalink® from Air Products), 1,2-bis(2-aminophenylthio)ethane, N,N′-dialkyl-p-phenylenediamine, N,N′-dialkyl-4,4′-diaminodiphenylmethane, 2-methylpropyl 4-chloro-3,5-diaminobenzoate and tert-butyl 4-chloro-3,5-diaminobenzoate.

It is also possible to use polyamines in the form of derivatives in which some or all of the amino groups have been blocked and react with isocyanates only after they have been activated by hydrolysis and/or heating. Examples of polyamine derivatives of this kind with blocked amino groups are aldimines, ketimines, enamines, oxazolidines, aminals, ammonium carbonates, amine-carbonic salts (carbamates) or amine-metal complexes. It is likewise possible to use polyamines which are microencapsulated or adsorbed on a zeolite.

The adduct of the formula (I) is typically present in an amount of 0.1% to 10% by weight, preferably 0.3% to 6% by weight and in particular 0.5% to 5% by weight, based on the two-component composition.

It is essential here that the preparation of the adduct of the formula (I) takes place separately from the preparation of component K1. The aliphatic oligomeric polyisocyanate of the formula (II) used to prepare the adduct of the formula (I) should not come into contact with a polyisocyanate which is part of component K1 before the reaction with the compound of the formula (III) is concluded. This ensures that the isocyanate-reactive group HX of the compound of the formula (III) reacts exclusively with the isocyanate groups of the aliphatic oligomeric polyisocyanate of the formula (II). Thus for the preparation of component K1 it is possible first to prepare the adduct of the formula (I) and to mix the polyisocyanate of component K1 into said adduct, or to mix the separately prepared adduct of the formula (I) into the polyisocyanate of component K1.

It is advantageous for the two-component composition to include at least one catalyst KAT-2. Suitable KAT-2 catalysts are compounds which accelerate the curing of the polymer composition. Specific suitable KAT-2 catalysts include on the one hand the catalysts KAT-1 already mentioned, and also further catalysts, examples being compounds of zinc, manganese, iron, chromium, cobalt, copper, nickel, molybdenum, lead, cadmium, mercury, antimony, vanadium, titanium, zirconium or potassium, such as zinc(II) acetate, zinc(II) 2-ethylhexanoate, zinc(II) laurate, zinc(II) oleate, zinc(II) naphthenate, zinc(II) acetylacetonate, zinc(II) salicylate, manganese(II) 2-ethylhexanoate, iron(III) 2-ethylhexanoate, iron(III) acetylacetonate, chromium(III) 2-ethylhexanoate, cobalt(II) naphthenate, cobalt(II) 2-ethylhexanoate, copper(II) 2-ethylhexanoate, nickel(II) naphthenate, phenylmercury neodecanoate, lead(II) acetate, lead(II) 2-ethylhexanoate, lead(II) neodecanoate, lead(II) acetylacetonate, aluminium lactate, aluminium oleate, aluminium(III) acetylacetonate, diisopropoxytitanium bis(ethyl acetoacetate), dibutoxytitanium bis(ethyl acetoacetate), dibutoxytitanium bis(acetylacetonate), potassium acetate, potassium octoate; tertiary amine compounds such as triethylamine, tributylamine, N-ethyl diisopropylamine, N,N,N′,N′-tetramethylethylenediamine, pentamethyldiethylenetriamine and higher homologues thereof, N,N,N′-N′-tetramethylpropylenediamine, pentamethyldipropylenetriamine and higher homologues thereof, N,N,N′,N′-tetramethyl-1-3-butanediamine, N,N,N′,N′-tetramethyl-1,6-hexanediamine, bis(dimethylamino)methane, N,N-dimethylbenzylamine,. N,N-dimethylcyclohexylamine, N-methyldicyclohexylamine, N,N-dimethylhexadecylamine, bis(N,N-diethylaminoethyl) adipate, N,N-dimethyl-2-phenylethylamine, tris(3-dimethylaminopropyl)amine, 1,4-diazabicyclo[2.2.2]-octane, 1,8-diazabicyclo[5.4.0]undec-7-ene (DBU), N-methylmorpholine, N-ethylmorpholine, N-cocomorpholine, N,N′-dimethylpiperazine, N-methyl-N′-dimethylaminoethylpiperazine, bis(dimethylaminoethyl)piperazine, 1,3,5-tris(dimethylaminopropyl)hexahydrotriazine or bis(2-dimethylaminoethyl) ether; aromatic nitrogen compounds such as 4-dimethylaminopyridine, N-methylimidazole, N-vinylimidazole or 1,2-dimethylimidazole; amidines and guanidines such as 1,1,3,3-tetra-methylguanidine; tertiary amine compounds containing active hydrogen atoms, such as triethanolamine, triisopropanolamine, N-methyldiethanolamine, N,N-dimethylethanolamine, 3-(dimethylamino)propyl-diisopropanolamine, bis(3-(dimethylamino)propyl)-isopropanolamine, bis(3-dimethylaminopropyl)amine, 3-(dimethylamino)propylurea, Mannich bases such as 2,4,6-tris(dimethylaminomethyl)phenol or 2,4,6-tris(3-(dimethylamino)propylaminomethyl)phenol, N-hydroxy-propylimidazole, N-(3-aminopropyl)imidazole, and also alkoxylation and polyalkoxylation products of these compounds, an example being dimethylaminoethoxyethanol; organic ammonium compounds such as benzyltrimethyl-ammonium hydroxide or alkoxylated tertiary amines; so-called “delayed action” catalysts, which represent modifications of known metal catalysts or amine catalysts, such as reaction products of tertiary amines and carboxylic acids or phenols, formed for example from 1,4-diazabicyclo[2.2.2]octane or DBU and formic acid or acetic acid; and also combinations of the aforementioned compounds, especially of metallic compounds and compounds containing amino groups.

In addition to the adduct of the formula (I), to the polyisocyanate, to the polyol and/or polyamine and to the optional catalyst KAT-2 it is possible for the two-component composition to include further constituents, the use being possible of the same plasticizers, solvents, fillers, catalysts, reactive diluents, crosslinkers, latent polyamines, dryers, rheology modifiers, adhesion promoters, stabilizers, surface-active substances and biocides as already specified for the one-component composition, and also further substances typically used in two-component polyurethane compositions. The division of these additional constituents between components K1 and K2 is done in the way which is known to the skilled person for two-component polyurethane compositions.

Kept separately from one another, components K1 and K2 are each stable on storage. Component K1 in particular must be prepared and stored in the absence of moisture.

The two components K1 and K2 are mixed with one another in an appropriate way only a short time before application, it being necessary to ensure that, in the course of the mixing operation, as little air as possible enters the mixed composition and that a suitable mixing ratio is observed. As soon as the two components come into contact with one another, the reactive constituents they contain begin to react with one another and so lead to the curing of the mixed two-component composition. In particular the isocyanate groups of component K1 react with the hydroxyl and/or amine groups of component K2. The curing of the mixed two-component composition can take place at room temperature; alternatively, if appropriate, it can be accelerated by supply of heat, especially when the composition contains slow-reacting polyols or polyisocyanates, or if it contains thermally latent polyamines, such as amine-metal complexes or microencapsulated polyamines, which react with the polymer P only after an activation temperature has been exceeded, 80 to 160° C. for example.

The mixing ratio between components K1 and K2 is typically selected such that a certain excess of isocyanate groups is present in relation to groups, such as hydroxyl groups and amino groups, that are reactive with isocyanate groups. Typically the mixing ratio is selected such that the ratio ([OH]+[NH])/[NCO] has a value of 0.5 to 0.95. This ensures that the mixed two-component composition cures to a polymeric material, with excess isocyanate groups reacting either with moisture from component K2 or with humidity from the air. It is likewise necessary to ensure that the amount of time elapsing between the mixing of the components K1 and K2 and the application of the mixture to a substrate surface is not too great, since excessive preliminary reaction prior to application makes it more difficult for effective substrate adhesion to be developed.

In the cured state, the one- or two-component compositions possess very good mechanical properties, in particular a high extensibility, which is of great importance in a multiplicity of applications, particularly those of the compositions as an elastic adhesive, elastic sealant or elastic coating.

The one-component and two-component compositions have broad possibilities for use as, for example, adhesives, sealants or coatings.

Examples of suitable applications are the adhesive bonding of components in construction or civil engineering and in the manufacture or repair of industrial or consumer products, particularly of means of transport such as water or land vehicles, preferably cars, buses and coaches, vans and lorries, trains or ships; the sealing of joints, seams or cavities in industrial manufacture or repair, or in construction or civil engineering; and the coating of various substrates, for example as a paint, varnish, primer, sealant or protective coating, or as a floorcovering, as for example for offices, living areas, hospitals, schools, warehouses and multi-storey car parks.

In one preferred embodiment the one-component or two-component compositions described are used as adhesives or sealants.

In the adhesive application the one-component composition or the mixed two-component composition is applied to a substrate S1 and/or a substrate S2. The adhesive can therefore be applied to one substrate or to the other substrate or else to both substrates. Thereafter the parts to be bonded are joined, whereupon the adhesive cures. It should be ensured here that the joining of the parts takes place within a time referred to as the open time, in order to ensure that both adherends are reliably bonded to one another.

In application as a sealant, the one-component composition or the mixed two-composition composition is applied between the substrates S1 and S2, and this is followed by curing. Typically the sealant is pressed into a joint.

In both applications the substrate S1 may be like or different from substrate S2.

Suitable substrates S1 or S2 are, for example, inorganic substrates such as glass, glass ceramic, concrete, mortar, brick, tile, plaster and natural minerals such as granite or marble; metals or alloys such as aluminium, steel, non-ferrous metals, galvanized metals; organic substrates such as wood, plastics such as PVC, polycarbonates, PMMA, polyesters, epoxy resins; coated substrates such as powder-coated metals or alloys; and also inks and paints. It is preferred for at least one of the substrates, S1 or S2, to be a paint, in particular an automotive topcoat, or a painted surface. Painted surfaces include, in particular, paint-coated materials such as wood, mineral materials such as rock, concrete, brickwork or the like, and also plastics, metals and metal alloys. In particular the substrate is a painted metal sheet.

By a “paint” is meant, in the present document, a cured synthetic-resin coating which is applied to a substrate for the purpose of protecting or enhancing its surface; the paint may be transparent or may comprise adjuvants, such as pigments, for example.

A “painted metal sheet” in the present document is a section of metal or metal alloy which-has been rolled out thinly and is coated with one or more paint coats, the topmost paint coat also being referred to as the “topcoat”.

A painted metal sheet often has not just one paint coat but instead a sequence of two or more paint coats, which may be like or different from one another. In vehicle construction in particular it is common for the painted metal sheet to be coated with a so-called paint system consisting, for example, of a prime coat, one or more pigmented paint coats and, lastly, a transparent topcoat. A typical paint system in vehicle construction may, for example, have the following appearance; 25 μm cathodic electrodeposition prime coat, 35 μm surfacer, 18 μm colour coat or metallic coat, and, lastly, 40 μm clearcoat. Examples of paints which find use in vehicle construction and are often difficult to bond are melamine-carbamates, silane-modified acrylic-melamines, silane-modified urethane-melamines, hydroxymelamines, two-component urethanes or acid-curing epoxides or epoxy-polyester hybrids.

As and when required, the substrates may be pretreated prior to the application of the adhesive or sealant. Pretreatments of this kind include, in particular, physical and/or chemical cleaning techniques, examples being sanding, sandblasting, brushing or the like, or treatment with cleaners or solvents, or the application of an adhesion promoter, an adhesive-promoter solution or a primer.

A “primer” for the purposes of the present document is a composition suitable as an undercoat which in addition to inert volatile substances and, optionally, solid adjuvants comprises at least one polymer and/or at least one substance containing reactive groups and is capable of curing on application to a substrate, to form a solid, effectively adhering film in a thickness of typically 10-15 μm, the curing coming about either solely by the evaporation of the inert volatile substances, such as solvents or water, for example, or by a chemical reaction, or by a combination of these factors, and the said primer developing effective adhesion to a subsequently applied layer—an adhesive, for example.

It has been found that the one-component or two-component compositions adhere in particular to paints without the need, prior to application of the adhesive or sealant, for pretreatment using adhesion promoters or primers. Accordingly, primerless bonding and sealing on paints is a possibility.

The adhesive or sealant is preferably applied uniformly.

It is possible for the one- or two-component composition to be applied at an elevated temperature, for example as a warm-melt adhesive, at temperatures between 40 and 80° C., or as a hot-melt adhesive, at temperatures between 80 and 200° C., in particular between 100 and 150° C.

After the bonding or sealing of the substrates S1 and S2 by means of a one- or two-component composition an adhesively bonded or sealed article is obtained. Such an article may be a built structure, in particular a built structure in construction or civil engineering, or a means of transport. Preferably the article is a means of transport, such as a water or land vehicle, for example, in particular a car, a bus or coach, a van or lorry, a train or a ship, or a component for external mounting thereon. With particular preference the adhesively bonded or sealed article is a means of transport, in particular a car, or a component for external mounting on a means of transport, in particular a car.

In one preferred embodiment of the invention the invention relates to a moisture-curing one-component adhesive which comprises at least one adduct of the formula (I) and also at least one polymer P which contains isocyanate groups and optionally silane groups, and which is used as an adhesive for elastic bonds in vehicle construction, in particular for the primerless bonding of paints, in particular of painted metal sheets carrying automotive topcoats.

In the majority of cases the elasticity is of substantial significance for the adhesive and sealant utility, but also for the coating utility. The reason for this is that the adhesive or sealant or the coating must be capable of reliably bridging different distances between adherends, such as those caused, for example, by dimensional tolerances or positioning differences on the part of the adherends or joint partners. Additionally the stresses, or forces, which come about through the different thermal expansion of the substrates or through the static or dynamic loading of the adhesive bond, seal or coating, must be able to be taken up and transmitted by the adhesive, sealant or coating without loss of the internal cohesion or of the adhesion to the substrates. Sealants in principle possess higher extensibility and lower tensile strength than adhesives. An elastic adhesive must be sufficiently extensiable after curing; in general it ought to have an elongation at break of at least 300%, in particular of at least 400%, preferably of at least 500%. Minimum values are often likewise imposed for the tensile strength, typically values of at least 5 MPa, in particular at least 7 MPa.

If the one-component or two-component composition is used as an adhesive for elastic bonds in vehicle construction it preferably has a paste-like consistency with properties of structural viscosity. An adhesive of this kind is applied to the substrate by means of a suitable apparatus, preferably in the form of a bead, and this bead may have a substantially round or triangular cross-sectional area. Suitable methods for applying the adhesive include, for example, its application from commercially customary cartridges which are operated manually or by means of compressed air, or from a drum or hobbock by means of a conveying pump or an extruder, where appropriate by means of an application robot. An adhesive having good application properties features firmness of consistency and short stringing. That is, it remains in the applied form following application, in other words does not run apart, and, after the application device has been set down, it forms only very short strings, if any at all, so that the substrate is not contaminated.

Elastic adhesive bonds in vehicle construction are, for example, the bonding attachment of parts, such as plastic covers, trim strips, flanges, bumpers, driver's cabs or other externally mounted components, to the painted bodywork of a means of transport, or the bonding of glass into the bodywork. Examples of vehicles that may be mentioned include cars, vans and lorries, buses and coaches, rail vehicles and ships.

It has been found that the compositions of the invention, comprising an adduct of the formula (I), exhibit significantly better adhesion to metal sheets coated with automotive topcoats, without primer pretreatment, than do analogous compositions containing no adduct of the formula (I).

### EXAMPLES

Description of Test Methods

Tensile strength and elongation at break were determined on films cured for 7 days under standard conditions (23±1° C., 50±5% relative humidity) with a thickness of 2 mm in accordance with DIN EN 53504 (pulling speed: 200 mm/min).

The adhesion was tested as follows:

A metal sheet painted as described below was wiped down once with an isopropanol-soaked cloth.

After an evaporation time of 1 hour, the respective adhesive was applied in the form of a triangular bead to the painted metal sheet, the bead measuring approximately 150 mm in length and approximately 10 mm in diameter. The metal sheet with the bead of adhesive was stored under standard conditions for 7 days, in the course of which the adhesive cured. Thereafter the adhesive bead was tested for adhesion as follows:

An incision was made into one end of the adhesive bead down to just above the paint surface. The incised end of the bead was held by hand and then pulled carefully and slowly from the paint surface with a peeling action, in the direction of the other end of the bead. If, in the course of this removal, the adhesion was so strong that the end of the bead threatened to tear off when being pulled, a cutter was used to apply a cut perpendicular to the bead-pulling direction, down to the bare paint surface, and. in this way a section of the bead was detached. Cuts of this kind were repeated, if necessary, in the course of continued pulling, at intervals of 2 to 3 mm. In this way the entire bead was pulled and/or cut from the paint surface. The adhesive properties were evaluated on the basis of the cured adhesive which remained on the paint surface after the bead had been removed (cohesive fracture), this being accomplished by estimating the cohesive fraction of the bond area, in accordance with the following scale:

1=more than 95% cohesive fracture

2=75-95% cohesive fracture

3=25-75% cohesive fracture

4=less than 25% cohesive fracture

5=0% cohesive fracture (purely adhesive fracture)

Test results with cohesive fracture values of less than 75% are considered inadequate.

The painted metal sheets were coated with a paint system composed of cathodic electrodeposition primer coat, surfacer, metallic paint and topcoat (clearcoat), the adhesive tests being carried out on the following topcoats:

Painted sheet 1: topcoat=clearcoat RK-8013 from DuPont

Painted sheet 2: topcoat=clearcoat RK-8046 from DuPont

Painted sheet 3: topcoat=clearcoat RK-8045 from DuPont

Preparation of Adducts

A-1

100 g (0.52 mol NCO groups) of hexamethylene diisocyanate trimer (isocyanurate type; Desmodur® N 3300, Bayer), 5.5 g (0.17 mol) of methanol and 0.1 g of dibutyltin dichloride were heated to 40° C in the absence of moisture and stirred at 40° C for 5 hours. As determined by titrimetry, the product had a free isocyanate group content of 13.2% by weight.

A-2

100 g (0.52 mol NCO groups) of hexamethylene diisocyanate trimer (isocyanurate type; Desmodur® N 3300, Bayer), 12.6 g (0.17 mol) of isobutanol and 0.1 g of dibutyltin dichloride were heated to 60° C. in the absence of moisture and stirred at 60° C. for 5 hours. As determined by titrimetry, the product had a free isocyanate group content of 12.6% by weight.

A-3

100 g (0.52 mol NCO groups) of hexamethylene diisocyanate trimer (isocyanurate type; Desmodur® N 3300, Bayer), 22.0 g (0.17 mol) of 2-ethyl-1-hexanol and 0.1 g of dibutyltin dichloride were heated to 60° C. in the absence of moisture and stirred at 60° C. for 2 hours. As determined by titrimetry, the product had a free isocyanate group content of 11.0% by weight.

A-4

100 g (0.52 mol NCO groups) of hexamethylene diisocyanate trimer (isocyanurate type; Desmodur® N 3300, Bayer), 32.4 g (0.17 mol) of 2-butyl-1-octanol, 0.1 g of dibutyltin dichloride and 60 g of tetraethylene glycol dimethyl ether were heated to 60° C. in the absence of moisture and stirred at 60° C. for 2 hours. As determined by titrimetry, the product had a free isocyanate group content of 7.2% by weight.

A-5

100 g (0.52 mol NCO groups) of hexamethylene diisocyanate trimer (isocyanurate type; Desmodur® N 3300, Bayer), 23.1 g (0.17 mol) of D,L-α,β-isopropylidene glycerol (Solketal®, Fluka), 0.1 g of dibutyltin dichloride and 51 g of tetraethylene glycol dimethyl ether were heated to 60° C. in the absence of moisture and stirred at 60° C. for 2 hours. As determined by titrimetry, the product had a free isocyanate group content of 7.5% by weight.

A-6

100 g (0.52 mol NCO groups) of hexamethylene diisocyanate trimer (isocyanurate type; Desmodur® N 3300, Bayer) and 22.0 g (0.17 mol) of dibutylamine were mixed in the absence of moisture, the mixture undergoing warming to 75° C. as a result of the exothermic reaction. Stirring was carried out for one hour. As determined by titrimetry, the product had a free isocyanate group content of 10.7% by weight.

A-7

100 g (0.52 mol NCO groups) of hexamethylene diisocyanate trimer (isocyanurate type; Desmodur® N 3300, Bayer), 34.8 g (0.17 mol) of 2-ethylhexyl thioglycolate and 0.1 g of dibutyltin dilaurate were heated to 60° C. in the absence of moisture and stirred at 60° C. for 10 hours. As determined by titrimetry, the product had a free isocyanate group content of 10.7% by weight.

A-8

100 g (0.55 mol NCO groups) of hexamethylene diisocyanate trimer (isocyanurate type; Desmodur® N 3600, Bayer), 21.0 g (0.16 mol) of 2-ethyl-1-hexanol and 0.1 g of dibutyltin dichloride were heated to 60° C. in the absence of moisture and stirred at 60° C. for 10 hours. As determined by titrimetry, the product had a free isocyanate group content of 11.9% by weight.

A-9

100 g (0.57 mol NCO groups) of hexamethylene diisocyanate trimer (iminooxadiazinedione type; Desmodur® XP 2410, Bayer), 21.0 g (0.16 mol) of 2-ethyl-1-hexanol and 0.1 g of dibutyltin dichloride were heated to 60° C. in the absence of moisture and stirred at 60° C. for 10 hours. As determined by titrimetry, the product had a free isocyanate group content of 13.4% by weight.

A-10

100 g (0.55 mol NCO groups) of hexamethylene diisocyanate trimer (biuret type; Desmodur® N 3200, Bayer), 22.7 g (0.18 mol) of 2-ethyl-1-hexanol and 0.1 g of dibutyltin dichloride were heated to 60° C. in the absence of moisture and stirred at 60° C. for 10 hours. As determined by titrimetry, the product had a free isocyanate group content of 11.7% by weight.

A-11

100 g (0.52 mol NCO groups) of hexamethylene diisocyanate oligomer (uretdione type; Desmodur® N 3400, Bayer), 13.5 g (0.10 mol) of 2-ethyl-1-hexanol and 0.1 g of dibutyltin dichloride were heated to 60° C. in the absence of moisture and stirred at 60° C. for 2 hours. As determined by titrimetry, the product had a free isocyanate group content of 15.0% by weight.

A-12

100 g (0.40 mol NCO groups) of isophorone diisocyanate trimer (isocyanurate type; Vestanat® T1890/100, Degussa), 18.2 g (0.14 mol) of 2-ethyl-1-hexanol, 0.1 g of dibutyltin dichloride and 60 g of tetraethylene glycol dimethyl ether were heated to 60° C. in the absence of moisture and stirred at 60° C. for 8 hours. As determined by titrimetry, the product had a free isocyanate group content of 5.9% by weight.

V-1 (Comparative)

100 g (0.52 mol NCO groups) of hexamethylene diisocyanate trimer (isocyanurate type; Desmodur® N 3300, Bayer), 36.7 g (0.18 mol) of 3-mercapto-propyltrimethoxysilane (Silquest® A-189, GE Advanced Materials), 0.1 g of dibutyltin dichloride and 60 g of tetraethylene glycol dimethyl ether were heated to 60° C. in the absence of moisture and stirred at 60° C. for 8 hours. As determined by titrimetry, the product had a free isocyanate group content of 6.9% by weight.

V-2 (Comparative) 100 g (0.52 mol NCO groups) of hexamethylene diisocyanate trimer (isocyanurate type; Desmodur® N 3300, Bayer), 57.8 g (0.17 mol) of polypropylene glycol monobutyl ether with a molecular weight of 340, 0.1 g of dibutyltin dichloride and 70 g of tetraethylene glycol dimethyl ether were heated to 60° C. in the absence of moisture and stirred at 60° C. for 8 hours. As determined by titrimetry, the product had a free isocyanate group content of 6.1% by weight.

V-3 (Comparative) 100 g (0.52 mol NCO groups) of hexamethylene diisocyanate oligomer (uretdione type; Desmodur® N 3400, Bayer), 260 g (0.26 mol) of polyethylene glycol monomethyl ether with a molecular weight of 1000, 160 g of tetraethylene glycol dimethyl ether and 0.1 g of dibutyltin dichloride were heated to 60° C. in the absence of moisture and stirred at 60° C. for 2 hours. As determined by titrimetry, the product had a free isocyanate group content of 1.6% by weight. In the course of storage a distinct increase in the viscosity became apparent.

Preparation of Adhesives

### Examples 1 to 17

In a vacuum mixer, the additions reported in Table 1 were added in the reported amount to 100 parts by weight in each case of base adhesive formulation and the mixture was processed to a homogeneous paste which was stored in the absence of moisture. Each mixture was used to carry out the tests reported in Table 1.

The base adhesive formulation was prepared as follows: In a vacuum mixer 2000 g of polymer 1, 2100 g of polymer 2, 1100 g of diisodecyl phthalate (Palatinol® Z, BASF), 600 g of urea thickener, 10 g of p-toluene-sulphonyl isocyanate (Zusatzmittel TI additive, Bayer), 2000 g of dried carbon black, 1700 g of calcined kaolin and 4 g of dibutyltin dichloride were processed to a homogeneous paste which was stored in the absence of moisture.

Polymer 1 was prepared as follows:

1295 g of Acclaim

s 4200 N polyol (low-monol polyoxypropylenediol, OH number 28.5 mg KOH/g; Bayer), 2585 g of Caradol® MD34-02 polyol (polyoxypropylene-polyoxyethylenetriol, OH number 35.0 mg KOH/g; Shell) 620 g of methylenediphenyl 4,4′-diisocyanate (MDI; Desmodur® 44 MC L, Bayer) and 500 g of diisodecyl phthalate (DIDP; Palatinol® Z, BASF) were reacted by a known process at 80° C. to form an NCO-terminated polyurethane polymer. As determined by titrimetry, the reaction product had a free isocyanate group content of 2.03% by weight.

Polymer 2 was prepared as follows:

1770 g of Acclaim

s 4200 N polyol (low-monol polyoxypropylenediol, OH number 28.5 mg KOH/g; Bayer), and 230 g of methylenediphenyl 4,4′-diisocyanate (MDI; Desmodur® 44 MC L, Bayer) were reacted by a known process at 80° C. to form an NCO-terminated polyurethane prepolymer. As determined by titrimetry, the reaction product had a free isocyanate group content of 1.97% by weight.

The urea thickener was prepared as follows:

In a vacuum mixer, 3000 g of diisodecyl phthalate (DIDP; Palatinol® Z, BASF) and 480 g of methylenediphenyl 4,4′-diisocyanate (MDI; Desmodur® 44 MC L, Bayer) were introduced and gently warmed. Then 270 g of monobutylamine were added slowly dropwise with vigorous stirring. The resulting paste was stirred for a further hour under vacuum and with cooling.

TABLE 1
Composition of adhesives, amounts in parts by
weight (pbw), and test results

| | 1 | 2 | 3 | | | | | |
|---|---|---|---|---|---|---|---|---|
| Example | Comp.¹ | Comp.¹ | Comp.¹ | 4 | 5 | 6 | 7 | 8 |
| Base adhesive | 100 | 100 | 100 | 100 | 100 | 100 | 100 | 100 |
| formulation | | | | | | | | |

| | | | | | | | | | |
|---|---|---|---|---|---|---|---|---|---|
| Adduct | Type | — | N3300² | V-1 | A-1 | A-2 | A-3 | A-4 | A-5 |
| | Amount | 0 | 3 | 3 | 3 | 3 | 3 | 3 | 3 |

| | | | | | | | | |
|---|---|---|---|---|---|---|---|---|
| Mechanical | | | | | | | | |
| properties: | | | | | | | | |
| TS³ [MPa] | 7.7 | 8.5 | 4.5 | 8.6 | 8.4 | 8.1 | 8.6 | 8.0 |
| EAB⁴ [%] | 670 | 230 | 180 | 490 | 540 | 560 | 600 | 560 |
| Adhesive | | | | | | | | |
| results: | | | | | | | | |
| Painted sheet 1 | 3 | 1 | 1 | 2 | 1 | 1 | 1 | 1 |
| Painted sheet 2 | 5 | 1 | 1 | 1 | 1 | 1 | 1 | 1 |
| Painted sheet 3 | 3 | 1 | 1 | 3 | 3 | 1 | 3 | 4 |

| | | | | | | | | | 16 | 17 |
|---|---|---|---|---|---|---|---|---|---|---|
| Example | | 9 | 10 | 11 | 12 | 13 | 14 | 15 | Comp.¹ | Comp.¹ |
| Base adhesive | | 100 | 100 | 100 | 100 | 100 | 100 | 100 | 100 | 100 |
| formulation | | | | | | | | | | |
| Adduct | Type | A-6 | A-7 | A-8 | A-9 | A-10 | A-11 | A-12 | V-2 | V-3 |
| | Amount | 3 | 3 | 3 | 3 | 3 | 3 | 3 | 3 | 3 |

| | | | | | | | | | |
|---|---|---|---|---|---|---|---|---|---|
| Mechanical | | | | | | | | | |
| properties: | | | | | | | | | |
| TS³ [MPa] | 7.3 | 8.4 | 7.9 | 8.2 | 8.1 | 7.3 | 8.0 | 7.2 | 4.5 |
| EAB⁴ [%] | 490 | 590 | 580 | 490 | 530 | 570 | 690 | 470 | 600 |
| Adhesive | | | | | | | | | |
| results: | | | | | | | | | |
| Painted sheet 1 | 1 | 1 | 1 | 1 | 1 | 1 | 1 | 1 | 1 |
| Painted sheet 2 | 1 | 1 | 1 | 1 | 1 | 2 | 2 | 5 | 5 |
| Painted sheet 3 | 1 | 2 | 1 | 1 | 1 | 2 | 3 | 5 | 5 |

¹comparative;
²no adduct, only Desmodur ® N3300 (Bayer);
³tensile strength;
⁴elongation at break

The results in Table 1 show the following inter alia:

Example 1 (comparative), without the addition of an adduct of the formula (I), does have a high value of elongation of break but also has inadequate adhesion to the painted metal sheets tested.

Example 2 (comparative), which instead of an adduct of the formula (I) contains Desmodur® N 3300, and Example 3 (comparative), which contains the adduct V-1 containing silane groups, both do have effective adhesion to the painted metal sheets tested, but have very low values of elongation of break, and so are unsuitable for use as elastic adhesives.

The inventive Examples 4 to 15, containing adducts A-1 to A-12, all have high to very high values of elongation of braek and generally effective to very effective adhesion to the painted metal sheets tested.

Examples 16 and 17 (comparative examples), which contain adducts of monoalcohols having more than 3 heteroatoms in total, exhibit inadequate adhesion to the painted metal sheets tested.

1. Adduct of the formula (I) 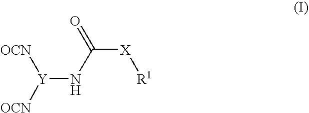
where
R¹ is a hydrocarbon radical which has 1 to 20 C atoms, may optionally contain up to 2 heteroatoms, but contains no silane group; 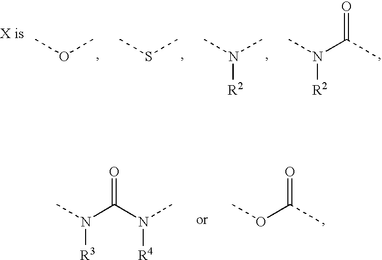
where
R² is a linear or branched hydrocarbon radical having 1 to 20 C atoms which optionally contains cyclic fractions and which optionally contains at least one functional group selected from the group comprising ether, sulphone, nitrile, nitro, carboxylic ester, sulphonic ester and phosphonic ester;
R³ and R⁴ independently are each a linear or branched hydrocarbon radical having 1 to 20 C atoms which optionally contains cyclic fractions,
or R³ and R⁴ together with the urea group form a five- or six-membered ring which optionally is substituted and which contains 3 to 20 C atoms;
and the dashed lines represent the bonds to C═O and R¹; and
Y is the radical of an oligomeric aliphatic polyisocyanate having three isocyanate groups, following the removal of all of the isocyanate groups.

2. Adduct of the formula (I) according to claim 1, characterized in that the adduct is prepared from the reaction between at least one oligomeric aliphatic polyisocyanate of the formula (II) and at least one compound of the formula (III)

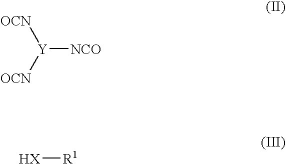

3. Adduct of the formula (I) according to claim 1, characterized in that the oligomeric aliphatic polyisocyanate is a trimer of hexamethylene 1,6-diisocyanate (HDI) and/or isophorone diisocyanate (IPDI).

4. Adduct of the formula (I) according to claim 2, characterized in that the compound of the formula (III) is an aliphatic monoalcohol or an aliphatic monothiol or a secondary aliphatic monoamine.

5. Adduct of the formula (I) according to claim 4, the compound of the formula (III) being 2-ethyl-1-hexanol or 2-ethylhexyl thioglycolate or dibutylamine or the diethyl ester of N-methylamino-, N-ethylamino-, N-propylamino-, N-butylamino- or N-(2-ethylhexyl)amino-succinic acid.

6. Process for preparing an adduct of the formula (I) according to any one of claim 1, which comprises reacting at least one oligomeric aliphatic polyisocyanate of the formula (II) with at least one compound of the formula (III).

7. Use of the adduct of the formula (I) according to any one of claim 1 as an adhesion promoter for polymer compositions containing isocyanate groups.

8. One-component composition comprising at least one adduct of the formula (I) according to any one of claim 1 and also at least one polymer P, which contains isocyanate groups and optionally silane groups.

9. One-component composition according to claim 8, characterized in that the polymer P is a polyurethane polymer P1 which contains isocyanate groups and is obtainable from the reaction of at least one polyisocyanate and at least one polyol.

10. One-component composition according to claim 8, characterized in that the polymer P is a polyurethane polymer P2 which contains not only isocyanate groups but also silane groups and is obtainable from the reaction of at least one polyurethane polymer P1 containing isocyanate groups,
itself obtainable from the reaction of at least one polyisocyanate and at least one polyol, and
an organoalkoxysilane having at least one isocyanate-reactive group, the organoalkoxysilane being used substoichiometrically in relation to the isocyanate groups.

11. One-component composition according to claim 10, characterized in that the organoalkoxysilane having at least one isocyanate-reactive group is a secondary aminosilane or a mercaptosilane.

12. One-component composition according to claim 10, characterized in that the ratio of isocyanate groups to silane groups is 10 to 1, in particular 6 to 2.

13. One-component composition according to claim 8, characterized in that the fraction of the adduct of the formula (I) is 0.1% to 10% by weight, preferably 0.3% to 6% by weight and in particular 0.5% to 5% by weight, based on the one-component composition.

14. One-component composition according to claim 9, characterized in that the polyol is a polyoxyalkylenepolyol, in particular a polyoxypropylenediol or -triol or an ethylene oxide-terminated polyoxypropylenediol or -triol.

15. One-component composition according to claim 14, characterized in that the polyol has a molecular weight of 1000 to 30000 g/mol and a level of unsaturation of less than 0.02 meq/g.

16. One-component composition according to claim 9, characterized in that the polyisocyanate is selected from the group comprising hexamethylene 1,6-diisocyanate (HDI), tolylene 2,4- and 2,6-diisocyanate (TDI), diphenylmethane 4,4′-, 2,4′- and 2,2′-diisocyanate (MDI) and isophorone diisocyanate (IPDI).

17. Two-component composition consisting of two components K1 and K2,
component K1 comprising at least one adduct of the formula (I) according to claim 1 and also at least one polyisocyanate, and
component K2 comprising at least one polyol and/or at least one polyamine.

18. Two-component composition according to claim 17, characterized in that the polyisocyanate is diphenylmethane 4,4′-, 2,4′- or 2,2′-diisocyanate (MDI) or polymeric MDI (PMDI) or a room-temperature-liquid form of MDI, or is a polyurethane polymer P1 prepared by using hexamethylene 1,6-diisocyanate (HDI); or diphenylmethane 4,4′-, 2,4′- or 2,2′-diisocyanate (MDI); or tolylene 2,4- or 2,6-diisocyanate (TDI); or diphenylmethane 4,4′-, 2,4′- or 2,2′-diisocyanate (MDI); or isophorone diisocyanate (IPDI).

19. Two-component composition according to claim 17, characterized in that the fraction of the adduct of the formula (I) is 0.1% to 10% by weight, preferably 0.3% to 6% by weight and in particular 0.5% to 5% by weight, based on the two-component composition.

20. Mixed two-component composition obtained by mixing components K1 and K2 of a two-component composition according to claim 17 in such a way that the isocyanate groups are used in excess in relation to the hydroxyl and/or amino groups, particularly such that the ratio ([OH]+[NH])/[NCO] has a value of 0.5 to 0.95.

21. Process for preparing a one-component composition according to claim 8, characterized in that the preparation of the adduct of the formula (I) and the preparation of the polymer P are carried out separately from one another.

22. Process for preparing a two-component composition according to claim 17, characterized in that the polyisocyanate is mixed with the adduct of the formula (I) following preparation of the latter.

23. Method of adhesive bonding comprising the steps of
a) applying a one-component composition according to a mixed two-component composition according to claim 20 to a substrate S1 and/or a substrate S2,
b) joining the adherends,
c) curing the composition,
the substrate S1 being like or different from substrate S2.

24. Method of sealing comprising the steps of
a) applying a one-component composition according to a mixed two-component composition according to claim 20 between the substrates S1 and S2,
b) curing the composition,
the substrate S1 being like or different from substrate S2.

25. Method according to claim 23, characterized in that at least one of the substrates S1 or S2 is a paint, in particular an automotive topcoat, or a painted surface.

26. Method according to claim 25, characterized in that the paint has not been pretreated with a primer.

27. Adhesively bonded or sealed article obtained by a method according to claim 23.

28. Adhesively bonded or sealed article according to claim 27, characterized in that the article is a means of transport, in particular a car, or a component for external mounting on a means of transport, in particular a car.
